(19) United States
(12) Patent Application Publication
(10) Pub. No.: US 2024/0385942 A1
(43) Pub. Date: Nov. 21, 2024

(54) CODE SCANNING AND OPERATION CONTROL

(71) Applicant: Microsoft Technology Licensing, LLC, Redmond, WA (US)

(72) Inventor: Michael A. HAWKER, Duvall, WA (US)

(21) Appl. No.: 18/317,530

(22) Filed: May 15, 2023

(51) Int. Cl. G06F 11/36

(52) U.S. Cl. CPC G06F 11/3608

(57) ABSTRACT

A code scanning system scans code to identify issues where a workaround has been implemented. The code scanning system automatically identifies a status corresponding to the identified issue and generates a suggested operation to perform based upon the issue and the identified status. The issue, the identified status, and the suggested operation can be surfaced for user interaction.

### BACKGROUND

Computing systems are currently in wide use. Some computing systems host or distribute applications that are accessed by end users. The hosted or distributed applications may provide a wide variety of different functionality.

Some such applications are generated using a continuous integration system in which multiple developers can collaborate in generating human readable code that is stored in a shared code base or code repository. Version control is used to resolve editing conflicts among the various developers, and build automation is used to create a machine runnable snapshot of a version of the code. That snapshot can then be distributed to end users through any of a variety of different networks. For instance, when the application is a web-based application, the snapshot created during the build process may be copied to a website where it can be accessed by users. When the application is a mobile application, then the snapshot created during the build process may be copied to a location where it can be downloaded by a user to a mobile device.

The discussion above is merely provided for general background information and is not intended to be used as an aid in determining the scope of the claimed subject matter.

### SUMMARY

A code scanning system identifies locations within source code or other sources of information where a workaround has been implemented to work around an issue. The code scanning system automatically identifies a status corresponding to the identified issue and generates a suggested operation to perform based upon the issue and the identified status. The issue, the identified status, and the suggested operation can be surfaced for user interaction or integration with other system(s).

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a computing system architecture.

FIG. 2 is a block diagram of one example of a code scanning system.

FIG. 3 is a flow diagram illustrating one example of the operation of a code scanning system.

FIG. 4 is a flow diagram illustrating one example of a code scanning operation, in more detail.

FIG. 5 is a flow diagram showing one example of surfacing a selectable suggested operation.

FIG. 6 is a block diagram showing the computing system architecture illustrated in FIG. 1, deployed in a remote server architecture.

FIG. 7 is a block diagram of one example of a computing environment.

### DETAILED DESCRIPTION

As discussed above, some computing systems use continuous integration systems to allow a plurality of different developers to collaborate on a code base that is stored in a code repository. Some portions of the code in the code base may depend on other code, and these portions of other code may thus be referred to as dependent code. It is common that, while writing code, a developer must workaround a known issue within the dependent code By “issue” it is meant, for example, that a piece of code is malfunctioning, crashing, or behaving in an undesired way and the malfunction, crash, or undesired behavior is caused by dependent code. In order to restore correct behavior, the developer may write extra code to work-around the malfunction, crash, or undesired behavior caused by the dependent code. The extra code is called a workaround.

When a developer generates code that is a workaround for an issue, the developer often marks the workaround with an identification number or uniform resource locator (URL) or another issue number or issue identifier that points to an issue record in an issue tracking system that a developer can access to see data about the issue, the status of the issue (such as whether the issue currently exists, has been resolved, will not be resolved, etc.), and/or other data. The issue tracking system may be developer's own issue tracking system, an issue tracking system of the developer's team, an issue tracking system for the dependent code, or another issue tracking system. In another example, the developer does not mark the workaround with a comment in the code, but instead marks the workaround in the issue tracking system by pointing back to the location in the code where the workaround is located, along with a link to an issue record in another issue tracking system.

When the issue is fixed, it is preferred that the workaround code be moved, or that other operations be performed in order to maintain the behavior and/or desired outcome of the code in the code base given the change in status of the issue. However, this is a laborious and error prone process in which a developer tries to locate issues in the code base, identify the status of those issues to determine whether the status has changed and, if so, performs an operation to clean up the code in the code base given the change in status. This process is cumbersome, error prone, and takes a great deal of time and, as a consequence, is not always done accurately and, in many cases, it is not done at all until something goes wrong when running the code.

The present discussion thus proceeds with respect to a code scanning system that may be triggered automatically or manually. The code scanning system scans the code in the code base to locate issue identifiers that identify issues for which a corresponding workaround has been implemented. The code scanning system automatically identifies the status of each issue to determine whether there has been a status change. If there has been a status change, the code scanning system identifies one or more suggested operations that should be performed in response to the status change and generates an output identifying the issue, the status change, and the suggested operations, for operator interaction. In one example, the suggested operations are automated so that the user simply needs to select a suggested operation and the code scanning system automatically performs that operation. Also, in one example, the code scanning system surfaces, for the user, location identifiers locating the different places in the code where the issue is referenced so that the suggested operations can be performed at each of those locations in the code. Issue identification is thus more accurate and thorough, the operations suggested are more accurate and more easily performed, and the code is thus maintained in a more accurate and thorough way.

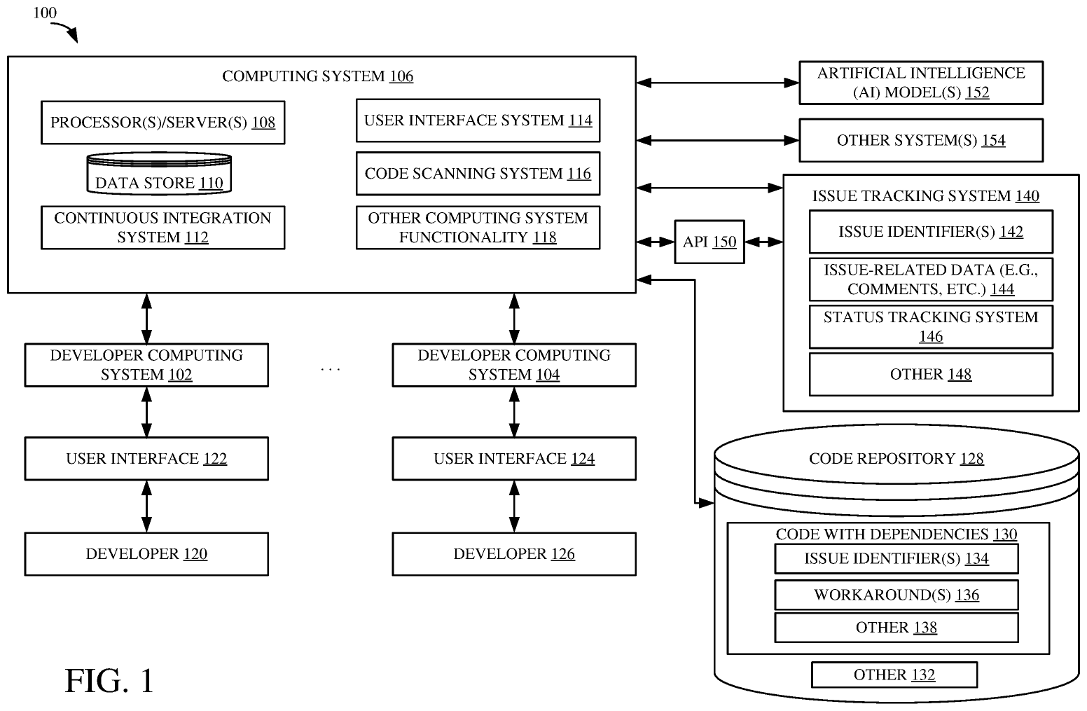

FIG. 1 is a block diagram showing one example of a computing system architecture 100. In architecture 100, a plurality of developer computing systems 102-104 have access to computing system 106 which includes one or more processors or servers 108, data store 110, continuous integration system 112, user interface system 114, code scanning system 116, and other computing system functionality 118. FIG. 1 shows that developer 120 has access to developer computing system 102 through user interface 122. Developer 120 can interact with user interface 122 in order to control and manipulate developer computing system 102 and parts of computing system 106. Also, developer computing system 104 generates user interface 124 for interaction by developer 126. Developer 126 can interact with user interface 124 in order to control and manipulate developer computing system 104 and some parts of computing system 106.

In the example shown in FIG. 1, computing system architecture 100 also includes code repository 128 that may include code 130 that has external dependencies, and other items 132. Code 130 can include issue identifiers 134, workarounds 136, and other items 138. By way of example, issue identifiers 134 identifies issues within code 130 for which a workaround 136 has been implemented. The issue identifiers 134 identify the issue within an issue tracking system 140. Issue tracking system 140 may index different issue records by issue identifiers 142 that identify the issues. The issue records may include issue-related data 144 which may, itself, include user comments, and other information describing the issue, describing potential workarounds for the issue, and describing other information relative to the issue.

Issue tracking system 140 also includes a status tracking system 146 that tracks the status of each of the issues and allows external systems to identify the status for each of the issues. By way of example, the status of an issue may indicate that the issue still exists, that the issue has been resolved, that the issue will not be resolved, etc. Issue tracking system 140 may include other items 148 as well. In the example shown in FIG. 1, issue tracking system 140 may expose an application programming interface (API) 150 for access by other systems, such as computing system 106.

FIG. 1 also shows that computing system architecture 100 may include, or have access to, artificial intelligence (AI) models 152 and any of a wide variety of other systems 154.

In one example, developer computing systems 102-104 allow developers 120-126 to collaborate on the code 130 in code repository 128 using continuous integration system 112. Therefore, continuous integration system 112 may have version control functionality, automated testing functionality, build functionality, code deployment functionality, and any of a wide variety of other systems or functional components that allow developers 120-126 to collaborate on and deploy code 130. Also, continuous integration system 112 allows developers 120-126, when they are developing or maintaining code, to insert issue identifiers 134 that identify issues for which a workaround 136 is needed. The issue identifiers 134 may be uniform resource locators (URLs) that can be navigated in order to access an issue record in issue tracking system 140 that describes the issue. The issue record may also identify the status of the issue. Further, the issue identifiers 134 may include a website or webpage, or another issue identifier that identifies the issue within an issue tracking system 140.

Developers 120-126 or other users may also have access to issue tracking system 140 where they can create or add to an entry or issue record for each issue and provide the issue identifier 142 and issue-related data 144 which describes the issue. Issue tracking system 140 may also allow developers or other users to provide comments or other issue-related data 144. The comments or other data 144 may provide suggested workarounds that can be used to temporarily address the issue, and a wide variety of other data. It will also be noted that there may be more than one issue tracking system 140 that each track different issues in code 130 or its dependencies. Therefore, an issue identifier 134 will also identify the particular issue tracking system that is tracking the status of the issue identified by issue identifier 134.

When an issue is resolved, the developer or other person that is responsible or accountable to the issue may update the issue-related data 144 and the status of the issue in status tracking system 146 to indicate that the issue is resolved.

Therefore, during development or maintenance of code 130, it may be that one or more of the issues identified by issue identifiers 134 have been resolved or have another status change. In that case, the workaround 136 corresponding to that issue should be deleted from code 130, and/or any of a wide variety of other operations should be performed to clean up code 130, given that the issue was resolved or its status has changed in another way.

Code scanning system 116 is intermittently triggered to scan code 130 and/or other sources of information about issues. Some of the triggers are described in greater detail elsewhere herein. When code scanning system 116 scans code 130 or the other sources, code scanning system 116 looks for issue identifiers 134 in code 130. When an issue identifier 134 is found, code scanning system 116 uses that issue identifier 134 to locate the corresponding issue record and access the status of the issue in the issue tracking system 140 where the issue is described.

Code scanning system 116 then determines whether system 116 needs to check for a status change for the particular issue. For instance, if code scanning system 116 just checked the status of this same issue several seconds earlier, then it may not need to perform another status check for this issue at this time. If, however, code scanning system 116 has not checked the status of this issue for an hour, or more, then it may be that code scanning system 116 determines that a status check should be performed. These times are only examples. When a status check is to be performed, code scanning system 116 accesses the status tracking system 146 in issue tracking system 140 for the particular issue identified by issue identifier 134 (which will match one of the issue identifiers 142). If there has been a status change, then code scanning system 116 surfaces that information for the developer 120-126 that is working on the portion of the code 130 where the issue was referenced (e.g., the code where issue identifier 134 is placed in a comment).

In one example, code scanning system 116 uses user interface system 114 to generate information indicative of a user interface that displays the issue, and the status change, to the relevant developer (for the purposes of the present discussion it will be assumed that developer 120 is the relevant developer). In another example, code scanning system 116 can use AI models 152 or other logic to identify suggested operations that developer 120 might perform based upon the change in status corresponding to the identified issue. For instance, code scanning system 116 can extract the issue-related data 144 and generate an AI prompt, based upon that data 144, to AI models 152. Code scanning system 116 can receive a response from AI models 152 where the response may identify the suggested operations, or other information that can be surfaced for developer 120.

In another example, code scanning system 116 can use logic to process the issue-related data 144 in a different way to identify workarounds that have been suggested in the comments of the issue record or suggested in other issue-related data 144. Using that information, code scanning system 116 can again scan code 130 to identify the portions of code 130 where the workarounds 136 have been implemented. Code scanning system 116 can then use user interface system 114 to generate information indicative of the locations in code 130 where the workarounds 136 are placed so that developer 120 can easily delete those workarounds 136 from code 130.

In another example, code scanning system 116 can generate a user interface that surfaces, for developer 120, a list of one or more suggested operations that should be performed based on the change in status corresponding to the identified issued, along with an actuator that allows developer 120 to select the suggested operation, in which case code scanning system 116 controls functionality to automatically perform the suggested operation without further user involvement. By “automatically” it is meant, in one example, that the function or operation is performed without further user involvement except, perhaps, to initiate or authorize the function or operation.

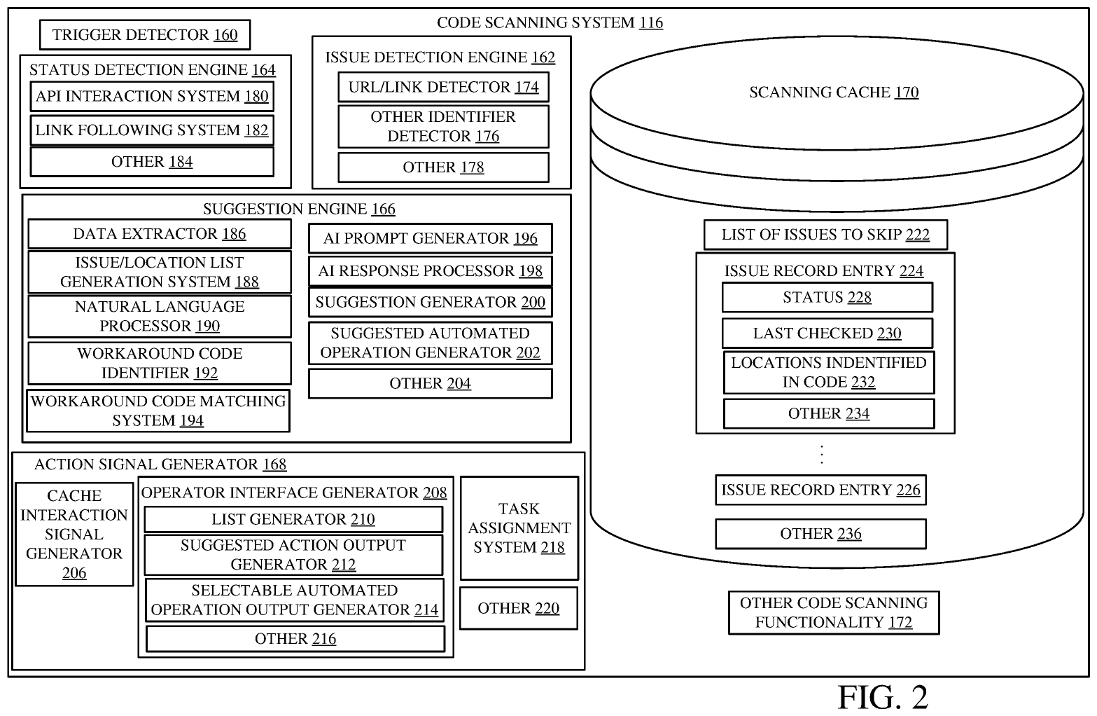

FIG. 2 is a block diagram showing one example of code scanning system 116.

FIG. 2 shows that, in one example, code scanning system 116 includes trigger detector 160, issue detection engine 162, status detection engine 164, suggestion engine 166, action signal generator 168, scanning cache 170, and other code scanning functionality 172. Issue detection engine 162 can include URL/link detector 174, other identifier detector 176 and other items 178. Status detection engine 164 can include API interaction system 180, link following system 182, and other items 184. Suggestion engine 166 can include data extractor 186, issue/location list generation system 188, natural language processor 190, workaround code identifier 192, workaround code matching system 194, AI prompt generator 196, AI response processor 198, suggestion generator 200, suggested, automated operation generator 202, and other items 204. Action signal generator 168 includes cache interaction signal generator 206, operator interface generator 208 (which, itself, includes list generator 210, suggested action output generator 212, selectable automated operation output generator 214, and other items 216), internal issue tracker interaction system 218, and other items 220. Also, in the example shown in FIG. 2, scanning cache 170 can include a list of issues to skip 222, issue record entries 224-226 (each of which include a status identifier 228, a last checked indicator 230, a location identifier 232, and other items 234), as well as any of a wide variety of other items 236. Before describing the operation of code scanning system 116 in more detail, a description of some of the items in system 116, and their operation, will first be provided.

Trigger detector 160 detects trigger criteria indicating that code scanning system 116 is to scan code 130 and/or other sources of information to look for any status changes corresponding to any identified issues. The trigger criteria can be time-based criteria so that trigger detector 160 detects a scanning trigger intermittently, based on time. The trigger criteria can be based on developer inputs so that developers 120-126 or other users can request code scanning system 116 to scan code 130 and/or other sources, or can perform an operation (such as opening a file) which may trigger code scanning. The trigger criteria can be operation-based criteria as well. For instance, when a build operation is performed, this may be an operation that triggers trigger detector 160 to cause code scanning system 116 to scan code 130 and/or other sources of information about issues. The trigger criteria can be any of a wide variety of other trigger criteria as well.

Once triggered, issue detection engine 162 scans code 130 looking for issue identifiers 134 in the code. It will be noted that issue detection engine 162 may also scan or access other items, in addition to, or instead of code 130 to identify issues. For example, issue detection engine 162 may access one or more issue tracking systems (such as issue tracking system 140) where an open issue in the issue tracking system points to an external dependency's issue tracker indicating that the issue in the dependency needs to be fixed before the corresponding workaround in code 130 is addressed. URL/link detector 174 looks for URLs or links in code 130 and/or in other sources of issue information, which may serve as issue identifiers 134. Other identifier detector 176 can be configured to look for any other types of issue identifiers, such as issue numbers, other symbols or other identifiers in code 130 (e.g., in the comments of code 130) and/or other sources of issue information which are used to identify issues.

When issue detection engine 162 identifies an issue identifier in code 130 and/or in another source of issue information, a signal is generated to status detection engine 164 causing status detection engine 164 to detect the status of the issue corresponding to the issue identifier that was just detected by issue detection engine 162. Where issue tracking system 140 exposes an API 150, API interaction system 180 calls the API 150 on the issue tracking system 140 and requests the status of the identified issue. For instance, API interaction system 180 may hand in the issue identifier in a call on API 150 and, in response, receive a status indicator indicating the status of the corresponding issue.

Where the issue identifier is a link, link following system 182 navigates that link to the location of issue tracking system 140 and uses the functionality of issue tracking system 140 to identify the status of the issue. By way of example, where the link following system 182 has navigated to a webpage corresponding to the issue, the webpage may include a keyword or phrase in a specific location or a colored symbol or other item that may indicate the status of the issue. In another example, the webpage may include an actuator button that can be actuated to obtain the current status of the corresponding issue. In that case, link following system 182 identifies the word or color or actuates the button to obtain the status of the issue.

It may be that issue tracking system 140 is a different type of issue tracking system where the status of the tracked issues are obtained in some other way. In that case, other functionality 184 can be used in status detection engine 164 to identify the status of an identified issue. The other functionality 184 may be for instance, a plug-in or extension that is instructive of how to obtain status from the issue tracking system.

In one example, once the status of an identified issue has been obtained, that information can be provided to suggestion engine 166 which can identify operations that will be suggested to developer 120 in response to the status change corresponding to the identified issue. For instance, issue/location list generation system 188 can identify in code 130 all of the locations where this particular issue is referred to. Those locations, along with the issue identifier and the status may be output, in list form, or in another form, to action signal generator 168 where action signals can be generated to surface that list for developer 120.

In another example, data extractor 186 extracts the issue-related data 144 for the identified issue and provides the extracted data to natural language processor 190. Natural language processor 190 can perform natural language processing on the issue-related data to understand the semantic content of that data in order to generate different suggested operations. For instance, processor 190 may identify certain portions of the issue-related data 144 as being code. In that case, workaround code identifier 192 may identify whether that code is a suggested workaround that has been suggested in the issue-related data 144. If so, workaround code matching system 194 can attempt to match that workaround against code 130 to determine whether developer 120 has implemented that particular workaround as a workaround 136 in code 130. When matching system 194 finds a match, this will indicate that developer 120 has used the identified code (identified by processor 190 and workaround code identifier 192) as a workaround 136 in the code 130. Therefore, suggestion generator 200 can generate an output to action signal generator 168 which can surface the locations of the workaround 136 in code 130 that should be deleted or otherwise modified given the change in status of the issue for which the workarounds 136 were implemented.

In another example, AI prompt generator 196 can obtain the extracted issue-related data 144 (extracted by data extractor 186) and use that data to generate a prompt to AI models 152. AI response processor 198 can receive the response from the AI models 152, in response to the prompt, and process that information to determine whether that information is useful in generating suggestions to developer 120.

The prompt, for instance, may include a description of the issue (or the issue identifier) the status change corresponding to that issue, whether any workarounds 136 have been identified as corresponding to that issue, and the issue-related data 144. The response from the AI models 152 may identify certain operations that should be performed given the AI prompt. Those operations may be, for instance, to delete the workarounds 136, to modify the workarounds 136, to update code 130 in other ways, to update other local or external systems, etc.

Suggestion generator 200 can generate an output indicative of all of the suggested operations, and suggested automation operation generator 202 can generate an output indicative of which of those suggested operations can be performed automatically. The outputs from suggestion engine 166 can be provided to action signal generator 168. Action signal generator 168 generates action signals to control different systems and subsystems based upon the outputs from suggestion engine 166. For instance, cache interaction signal generator 206 generates control signals to update scanning cache 170. Cache interaction signal generator 206 may generate action signals that, for example, update the issue record entry 224 corresponding to the identified issue to update the status indicator 228 to show the current status and the last checked indicator 230 to identify the time that the status was last checked for this issue. Generator 206 may generate signals to update the locations indicator 232 to identify the various locations in code 130 where this particular issue was referenced. Generator 206 can generate other action signals to update scanning cache 170 in other ways as well.

Operator interface generator 208 generates action signals that can be used to cause the display of certain information to developer 120, or to output or surface that information for use by developer 120 in other ways. For instance, list generator 210 can generate action signals indicative of the list of issues and status corresponding to those issues for developer 120. List generator 210 can include other information as well, such as the various locations in code 130 where the issue is encountered, so that developer 120 can quickly locate those locations in code 130 to delete the workarounds or perform other operations. Suggestion action output generator 212 generates signals which can be used to display to developer 120 the suggested operations or actions that are to be performed given the status change for the identified issue. Those operations or actions may be, for instance, to delete the corresponding workarounds, to modify those workarounds, to modify code 130 in other ways, etc. Selectable automated operation output generator 214 generates action signals that can be used to display to developer 120 a set of selectable, automated operations that can be selected by developer 120, and automatically performed. Those actions can be the same as the suggested actions or operations output by generator 212, or different actions or operations.

Task assignment system 218 can generate signals to interact with a scheduling system or a workload management system or other system to generate or modify a record identifying the issue, that a status change has been detected for that issue, and the suggested operations that are to be performed. In this way, the record in the scheduling or workload management system can be assigned to a particular user or group of users for resolution. In another example, a flag may be set in the issue tracking system that is following this issue to indicate to, or alert, a person or group of people that the workaround should be fixed, based on the status change. By way of example, the scheduling or workaround management system may surface the issues to a manager or other developer who can assign those issues to different people. Those people can then access the issue to see the suggested operations that may be performed, the selectable automated operations that may be performed, etc., and then resolve those issues accordingly.

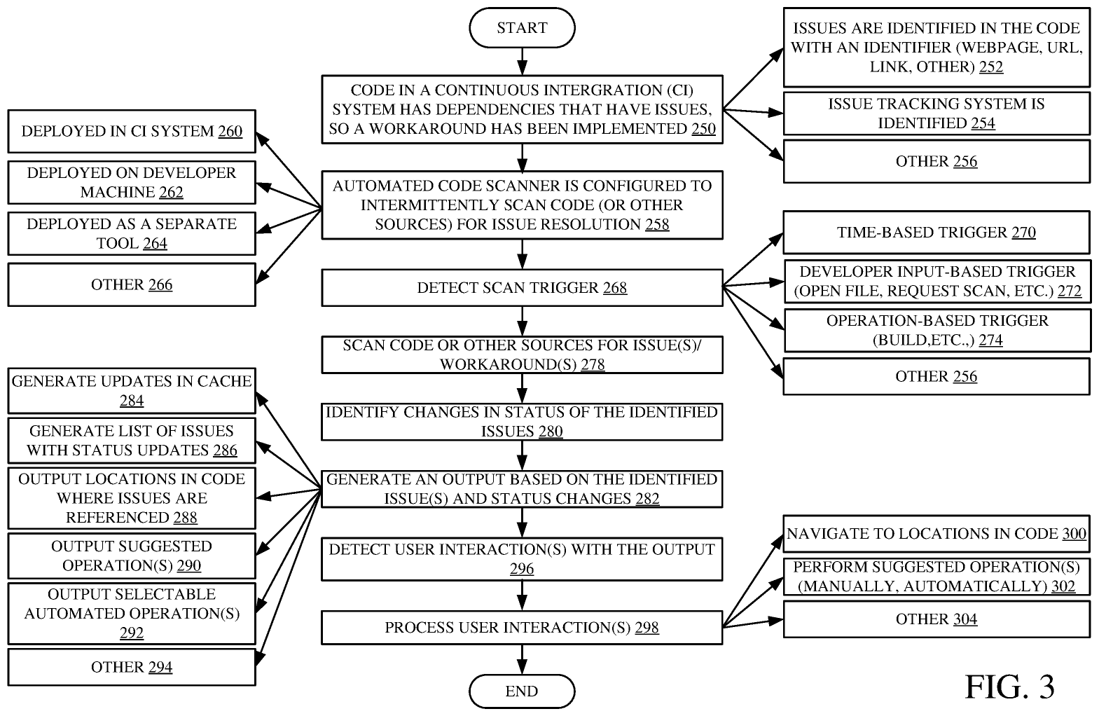

FIG. 3 is a flow diagram illustrating one example of the overall operation of code scanning system 116. In FIG. 3, it is assumed that code 130 is being developed or maintained through a continuous integration system and may have dependencies that have issues so that a workaround 136 has been implemented in the code 130, as indicated by block 250 in the flow diagram of FIG. 3. In one example, the issues are identified by issue identifiers 134 in the code, where the issue identifiers 134 may be in the form of a reference to a webpage, a URL, another type of link, or other issue identifier, as indicated by block 252 in the flow diagram of FIG. 3. It is also assumed that the issues are being tracked by one or more issue tracking systems 140 that are identified by the issue identifiers 134, as indicated by block 254 in the flow diagram of FIG. 3. The code and issues may be generated and identified in other ways as well, as indicated by block 256.

It is also assumed that an automated code scanner (e.g., code scanning system 116) is configured to intermittently scan code 130 in order to surface information to enhance issue resolution, as indicated by block 258 in the flow diagram of FIG. 3. It will be noted that, while code scanning system 116 is shown as a separate tool in FIG. 1, system 116 could be deployed within the continuous integration system 112 and triggered when a build operation is performed, or in other ways. Deploying the code scanning system 116 in the continuous integration system 112 is indicated by block 260 in the flow diagram of FIG. 3. It should also be noted that code scanning system 116 could be deployed in each of the developer computing systems 102-104, as indicated by block 262, or as a separate tool that is accessed either within computing system 106 or that is accessed externally to computing system 106, as indicated by block 264 in the flow diagram of FIG. 3. The code scanning system 116 can be deployed in other ways as well, as indicated by block 266 in the flow diagram of FIG. 3.

At some point, trigger detector 160 detects a scan trigger indicating that code scanning system 116 is to scan code 130. Detecting a scan trigger is indicated by block 268 in the flow diagram of FIG. 3. As discussed above, trigger criteria may be time-based trigger criteria, as indicated by block 270, or developer input-based trigger criteria, as indicated by block 272. The developer input-based trigger criteria may be a developer input requesting a scan, or developer operation that triggers a scan (such as opening a file, etc.) or another developer input. The trigger criteria may be operation-based trigger criteria (such as when continuous integration system 112 performs a build operation, or another operation), as indicated by block 274. The scanning trigger criteria may be any of a wide variety of trigger criteria as well, as indicated by block 276 in the flow diagram of FIG. 3.

Issue detection engine 162 then scans code 130 and/or other sources of information for issues identified by issue identifiers 134, that may have workarounds 136 associated with them. As discussed above, issue identifiers 134 can include webpages, URL, link, etc. Scanning the code and/or other sources of information for issues and workarounds is indicated by block 278 in the flow diagram of FIG. 3.

When an issue identifier 134 is located in code 130, then status detection engine 164 identifies any changes in status corresponding to the identified issue, as indicated by block 280. Identifying status can be done in a variety of different ways, such as accessing API 150, or using another technique.

Suggestion engine 166 and action signal generator 168 then generate an output based upon the identified issues and any status changes that have been identified, as indicated by block 282 in the flow diagram of FIG. 3. For example, suggestion engine 166 and action signal generator 168 may generate an output to update scanning cache 170, as indicated by block 284. The output from engine 166 and/or generator 168 may generate a list of issues with status updates, as indicated by block 286. The output from engine 166 and/or generator 168 may include the locations in code 130 where the issues are referenced, as indicated by block 288. The output from engine 166 and/or generator 168 may identify suggested operations 290 that are to be performed, and also selectable, automated operations that may be performed, as indicated by block 292. The output from engine 166 and/or generator 168 can include a wide variety of other information as well, as indicated by block 294 in the flow diagram of FIG. 3. The outputs may be used to generate an interface for a developer (such as developer 120) through user interface system 114 where developer 120 can interact with the user interface.

User interface system 114 may then receive an indication indicating that user interactions with the user interface have been detected, as indicated by block 296 in the flow diagram of FIG. 3. Those user interactions will then be processed, as indicated by block 298. For instance, the user interactions may be inputs that cause continuous integration system 112 to navigate to the locations of the issues, in code 130, identified in the user interface output to developer 120. Navigating to those locations is indicated by block 300 in the flow diagram of FIG. 3. The user interactions may be that developer 120 selects an automated, suggested operation or a manually performed operation, in which case those operations are performed (automatically or manually) as indicated by block 302 in the flow diagram of FIG. 3. The user interactions with the user interface output may take other forms and be processed in other ways as well, as indicated by block 304 in the flow diagram of FIG. 3.

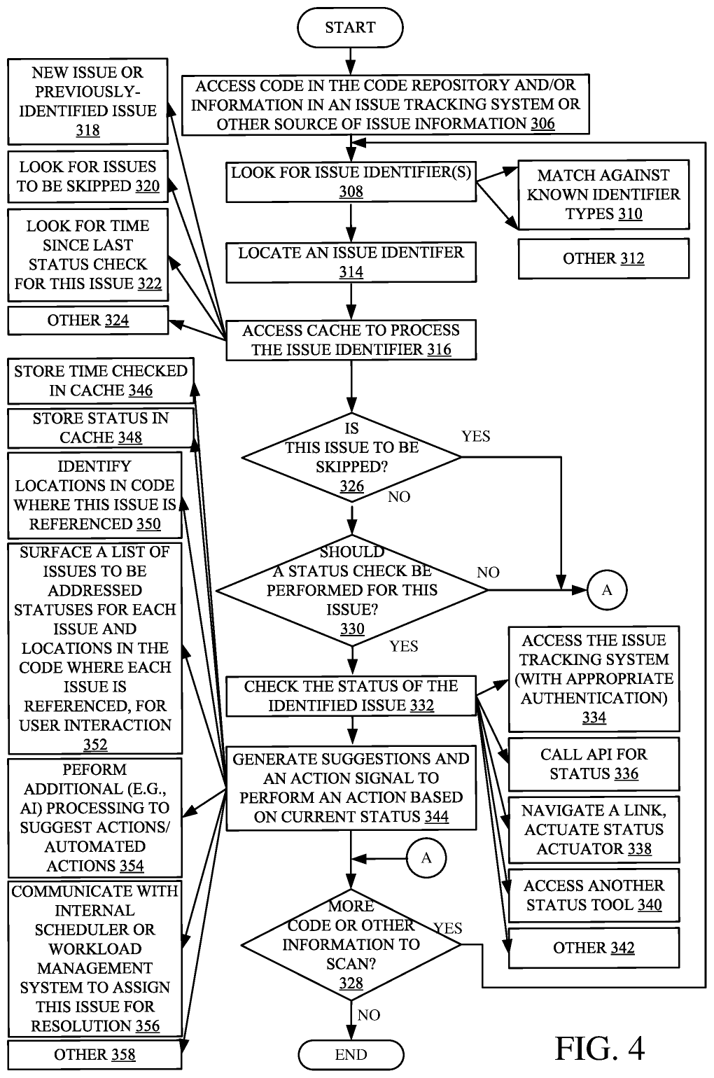

FIG. 4 is a flow diagram illustrating one example of how a code scanning operation is performed, in more detail. It is assumed that trigger detector 160 has detected a trigger indicating that code scanning system 116 should scan code 130 and/or other sources of information. Issue detection engine 162 accesses code 130 in repository 128 and/or other sources of information, as indicated by block 306 in the flow diagram of FIG. 4. For instance, issue detection engine 162 may be given the address within the location in code repository 128 where the code 130 is to be scanned or a webpage for an issue tracker that is to be scanned, etc. Issue detection engine 162 can then begin scanning the code 130 and/or other sources at that location.

Issue detection engine 162 scans the code and/or other source, looking for issue identifiers 134, as indicated by block 308 in the flow diagram of FIG. 4. In doing so, issue detection engine 162 can match entries in comments, for instance, against known identifier types to see whether the comments include issue identifiers, or whether the issue identifiers 134 are located elsewhere in code 130. Matching against known issue identifier types is indicated by block 310 in the flow diagram of FIG. 4. Issue detection engine 162 can detect issue identifiers in other ways as well, as indicated by block 312.

When issue detection engine 162 locates an issue identifier, as indicated by block 314 in the flow diagram of FIG. 4, then issue detection engine 162 accesses scanning cache 170 to determine how to process the issue corresponding to the issue identifier. Accessing the cache 170 is indicated by block 316 in the flow diagram of FIG. 4.

For instance, issue detection engine 162 can determine whether this issue identifier corresponds to a new issue or a previously identified issue based on whether an issue record entry is corresponding to this issue identifier is stored within scanning cache 170. Determining whether the issue a new or previously viewed issue is indicated by block 318 in the flow diagram of FIG. 4. Issue detection engine 162 can also access the list of issues to skip 222 to see whether the issue identifier that has just been located is in that list 222. For instance, it may be that developers provide an input instructing code scanning system 116 to always skip certain issue identifiers. In that case, the issue identifiers are placed in the list of issues to skip 222 so that they can be skipped during subsequent scanning operations. Looking for the issue identifier in the list of issues to skip 222 is indicated by block 320 in the flow diagram of FIG. 4. Issue detection engine 162 can also access the last checked indicator 230 to determine how long it has been since the status of this issue was last checked, as indicated by block 322 in the flow diagram of FIG. 4. Issue detection engine 162 can process other information in cache 170 or in issue records 224-226, as well, as indicated by block 324 in the flow diagram of FIG. 4.

If the issue identifier is in the list of issues to skip 222, as indicated by block 326 in the flow diagram of FIG. 4, then processing continues at block 328 where issue detection engine 162 determines whether there is more code to scan in code 130 and/or other information to scan in other sources. However, if, at block 326, it is determined that the issue identifier is not in the list of issues to skip 222, then issue detection engine 162 determines whether the status of the corresponding issue should be checked (for instance, based upon the time since the status was last checked), as indicated by block 330. Again, if the status need not be checked (because, for example, it was checked recently), then processing again skips to block 328. However, if at block 330 it is determined that the status of this issue should be checked, then status detection engine 164 accesses the issue tracking system 140 that is tracking this issue to check on the status of the identified issue, as indicated by block 332 in the flow diagram on FIG. 4.

Where issue tracking system 140 has an authentication process, then status detection engine 164 executes that authentication process to access issue tracking system 140, as indicated by block 334 in the flow diagram of FIG. 4. Where issue tracking system 140 exposes API 150, then API interaction system 180 can call API 150 for the status of the identified issue, as indicated by block 336 in the flow diagram of FIG. 4. Where the status identifier includes a link to a webpage, for instance, then link following system 182 navigates that link to the webpage and then actuates any actuator or performs any other operations on that webpage in order to obtain the status of the corresponding issue, as indicated by block 338 in the flow diagram of FIG. 4.

Status detection engine 164 can access the issue tracking system 140 in other ways that may be specific to the issue tracking system 140, or in other known ways, in order to obtain the status of the identified issue, as indicated by blocks 340 and 342 in the flow diagram of FIG. 4. By way of example, it may be that an issue tracking system 140 has a separate status tool that is to be used in order to identify the status of a particular issue being tracked. That status tool may be accessed by status detection engine 164, as indicated by block 340. The status of the issue may be identified in other ways as well, as indicated by block 342.

Suggestion engine 166 then generates an output indicative of suggestions of operations to be performed, and action signal generator 168 generates an action signal to perform one or more of the suggested operations. Generating suggestions and an action signal based on the current status of an issue is indicated by block 344 in the flow diagram of FIG. 4. For instance, cache interaction signal generator 206 may interact with scanning cache 170 to update the issue record entry 224 corresponding to the identified issue to update the last checked indicator 230 to indicate the last time that the status was checked, as indicated by block 346 in the flow diagram of FIG. 4. The updated status may be stored as the status indicator 228 in the corresponding issue record entry 224 in cache 170 as well, as indicated by block 248 in the flow diagram of FIG. 4. Issue location list generation system 188 can identify all of the locations in code 130 where this issue was referenced, as indicated by block 350 in the flow diagram of FIG. 4. Operator interface generator 208 can then surface, for user interaction, a list of the issues to be addressed, the statuses or status changes for each issue, and the locations in code 130 where each issue is referenced. Such a user interface can be surfaced for developer 120, for interaction by developer 120, or for reference by developer 120, as indicated by block 252 in the flow diagram of FIG. 4.

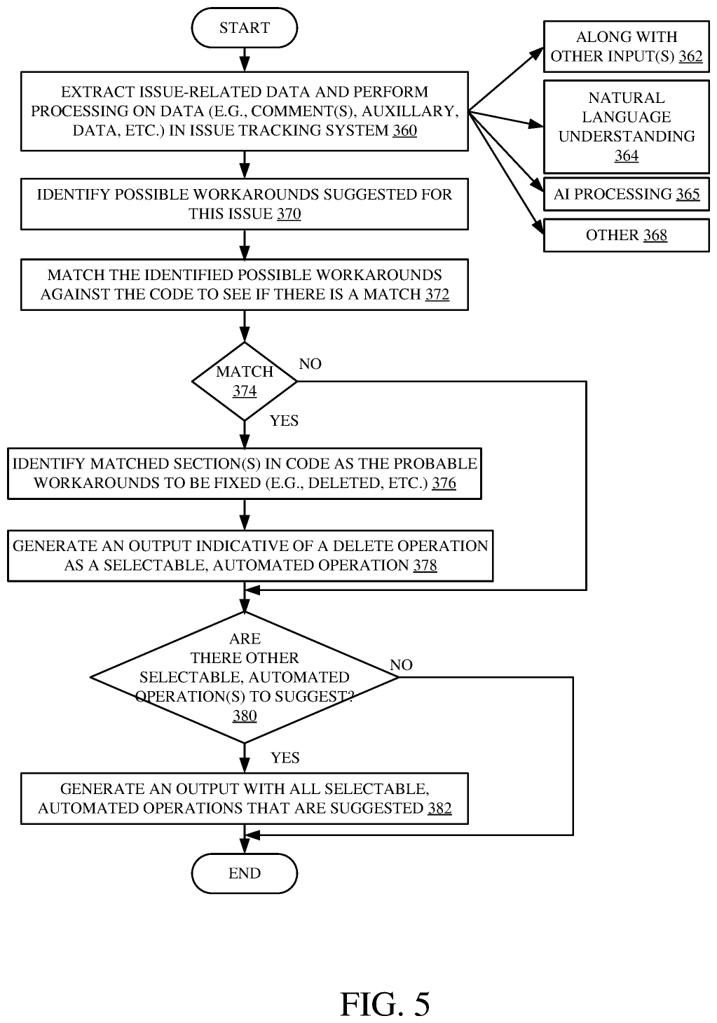

Suggestion engine 166 can perform any of a wide variety of additional processing (such as artificial intelligence processing, natural language processing, or other processing) in order to generate additional suggested actions, and/or automated actions that can be performed in response to the status changes corresponding to the identified issue. Performing such additional processing is indicated by block 354 in the flow diagram of FIG. 4 and described in greater elsewhere herein, such as below with respect to FIG. 5 and elsewhere.

Task assignment system 218 may communicate with an internal scheduler or workload management system (that is internal to computing system 106 or internal to continuous integration system 112), to create a record in such system for each issue so that a developer or other user can be assigned to that record to resolve code 130 (by performing any suggested operations or other operations in code 130) based upon the change in status for the identified issue. Communicating with an internal scheduler or workload management system to assign the issue for resolution is indicated by block 356 in the flow diagram of FIG. 4. Other suggestions and other action signals can be generated as well, as indicated by block 358 in the flow diagram of FIG. 4.

FIG. 5 is a flow diagram illustrating one example of the operation of suggestion engine 166 and action signal generator 168, in more detail. Data extractor 186 accesses the issue-related data in issue tracking system 140 and extracts that data so that processing can be performed on the data. For instance, data extractor 186 may extract the comments from a webpage or comment thread dealing with the identified issue. There may be other sources of data that are extracted from other data stores as well. For instance, developer 120 may have a private data store where developer 120 is storing information about the identified issue, separate from the data in issue tracking system 240. Data extractor 186 can extract that data as well. Once the relevant data has been extracted, the data can be processed to identify information that may be used in generating suggestions, selectable automated operations, etc. Extracting the issue-related data (and possibly other data) and performing processing on that data is indicated by block 360 in the flow diagram of FIG. 5. Other user inputs or inputs from other sources may be included in that processing as well, as indicated by block 362.

In one example, the data is processed by natural language processor 190 to obtain a semantic understanding of the data, as indicated by block 364. In another example, the extracted data is used by AI prompt generator 196 to generate a prompt for AI models 152, as indicated by block 366. The data can be extracted, and it can be processed in other ways, as indicated by block 388.

In one example, workaround code identifier 192 identifies different code patterns or code snippets that have been suggested in the extracted data as possible workarounds that can be used to address the identified issue. For example, natural language processor 190 or AI response processor 198 can identify pieces of code in the issue-related data that appear to be possible or suggested workarounds that may be implemented to address the identified issue. Workaround code matching system 194 can then attempt to match those pieces of code against corresponding pieces of code in code 130 to determine whether any of the potential workarounds have been implemented as workarounds 136 in code 130. When workaround code matching system 194 finds code in code 130 that matches one of the possible workarounds, then workaround code matching system 194 identifies that location in code 130 as a workaround 136 that should be addressed in response to the change in status of the identified issue. Identifying possible workarounds in the issue-related data is indicated by block 370 in the flow diagram of FIG. 5. Matching the identified possible workarounds against the code 130 to see if there is a match is indicated by block 372 in the flow diagram of FIG. 5. If there is a match, as determined at block 374 in the flow diagram of FIG. 5, then identifying the matched section in code 130 as the probable workarounds 136 to be fixed (e.g., deleted) in code 130 is indicated by block 376 in the flow diagram of FIG. 5.

Suggestion generator 200 can then generate a suggested operation to address the identified workarounds 136. For instance, the suggested operation may be to delete the workarounds 136 from code 130. If automatic deletion of the code is enabled, then suggested automation operation generator 202 can identify on a user interface that the delete operation is a selectable operation that can be selected by developer 120 and automatically performed. Suggestion engine 166 can then generate an output indicative of a delete operation as a selectable, automated operation, as indicated by block 378. Suggestion generator 200 may also determine that there are additional operations to suggest (such as code modifications, comment modifications, updates to different data stores, etc.). Some or all of those operations may be automated so that selectable automated operation generator 202 may generate an output indicative of those operations as being selectable, and automated operations. Determining whether there are other selectable, automated operations to suggest is indicated by block 380 in the flow diagram of FIG. 5. If so, then suggestion engine 166 generates an output with all of the selectable, automated operations that have been suggested, to action signal generator 168. Generating such an output is indicated by block 382 in the flow diagram of FIG. 5.

As discussed above, action signal generator 168 can generate action signals based upon the output from suggestion engine 166 indicative of suggested operations, selectable, automated suggested operations, or other outputs from suggestion engine 166.

It can thus be seen that the present description describes a system in which code scanning system 116 can be automatically triggered to scan code 130, that is being worked on and maintained through a continuous integration system (and/or other sources of information about issues), to identify issues and to identify changes in status of those issues. Based upon the changes in status, code scanning system 116 can process issue-related data to identify suggested operations and surface those suggested operations for user action. Also, in one example, the suggested operations may be automated, so that they can be surfaced for the user as selectable, automated operations, in which case the user may perform those operations by simply selecting them from the user interface on which they are presented to the user. This greatly enhances the accuracy of the code 130, reduces errors that can be caused by changes in status of issues referenced in the code, or in code dependencies, and enhances the efficiency with which code can be developed and deployed.

It will be noted that the above discussion has described a variety of different systems, components, engines, generators, detectors, identifiers, and/or logic. It will be appreciated that such systems, components, engines, generators, detectors, identifiers, and/or logic can be comprised of hardware items (such as processors and associated memory, or other processing components, some of which are described below) that perform the functions associated with those systems, components, engines, generators, detectors, identifiers, and/or logic. In addition, the systems, components, engines, generators, detectors, identifiers, and/or logic can be comprised of software that is loaded into a memory and is subsequently executed by a processor or server, or other computing component, engines, generators, detectors, identifiers, as described below. The systems, components, engines, generators, detectors, identifiers, and/or logic can also be comprised of different combinations of hardware, software, firmware, etc., some examples of which are described below. These are only some examples of different structures that can be used to form the systems, components, engines, generators, detectors, identifiers, and/or logic described above. Other structures can be used as well.

The present discussion has mentioned processors and servers. In one example, the processors and servers include computer processors with associated memory and timing circuitry, not separately shown. The processors and servers are functional parts of the systems or devices to which they belong and are activated by, and facilitate the functionality of the other components or items in those systems.

Also, a number of user interface (UI) displays have been discussed. The UI displays can take a wide variety of different forms and can have a wide variety of different user actuatable input mechanisms disposed thereon. For instance, the user actuatable input mechanisms can be text boxes, check boxes, icons, links, drop-down menus, search boxes, etc. The mechanisms can also be actuated in a wide variety of different ways. For instance, the mechanisms can be actuated using a point and click device (such as a track ball or mouse). The mechanisms can be actuated using hardware buttons, switches, a joystick or keyboard, thumb switches or thumb pads, etc. The mechanisms can also be actuated using a virtual keyboard or other virtual actuators. In addition, where the screen on which the mechanisms are displayed is a touch sensitive screen, the mechanisms can be actuated using touch gestures. Also, where the device that displays them has speech recognition components, the mechanisms can be actuated using speech commands.

A number of data stores have also been discussed. It will be noted the data stores can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

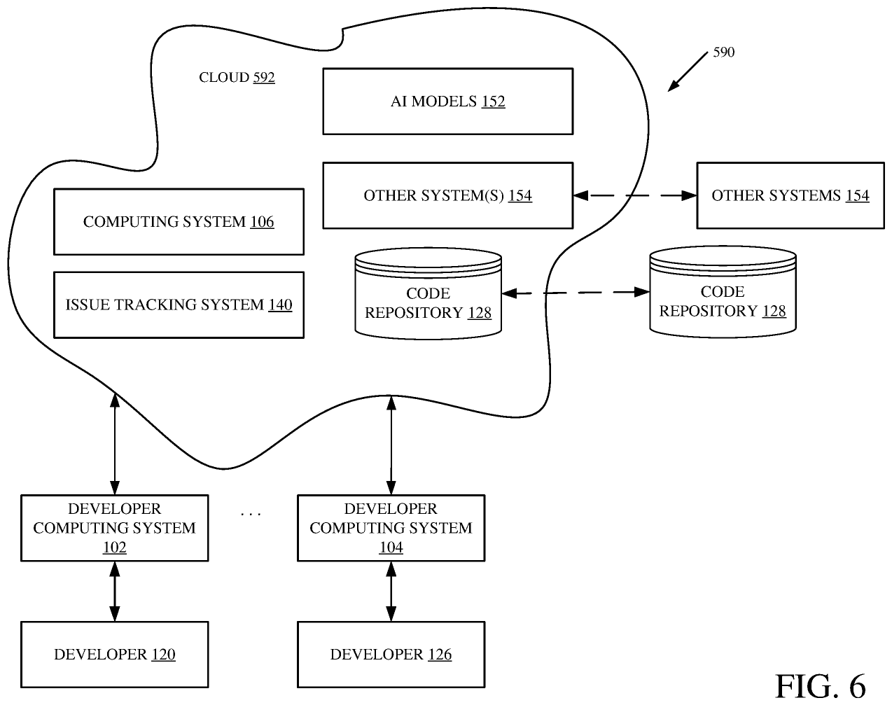

FIG. 6 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various examples, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 6, some items are similar to those shown in FIG. 1 and they are similarly numbered. FIG. 6 specifically shows that computing system 106, issue tracking system 140, AI models 152, other systems 154, and/or code repository 128 can be located in cloud 502 (which can be public, private, or a combination where portions are public while others are private). Therefore, developers 120, 126 use developer systems 102, 104 to access those systems through cloud 502.

FIG. 6 also depicts another example of a cloud architecture. FIG. 6 shows that it is also contemplated that some elements of computing system architecture 100 can be disposed in cloud 502 while others are not. By way of example, code repository 128 and/or other systems 154 or other items can be disposed outside of cloud 502, and accessed through cloud 502. Regardless of where the items are located, the items can be accessed directly by device 504, through a network (either a wide area network or a local area network), the items can be hosted at a remote site by a service, or the items can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

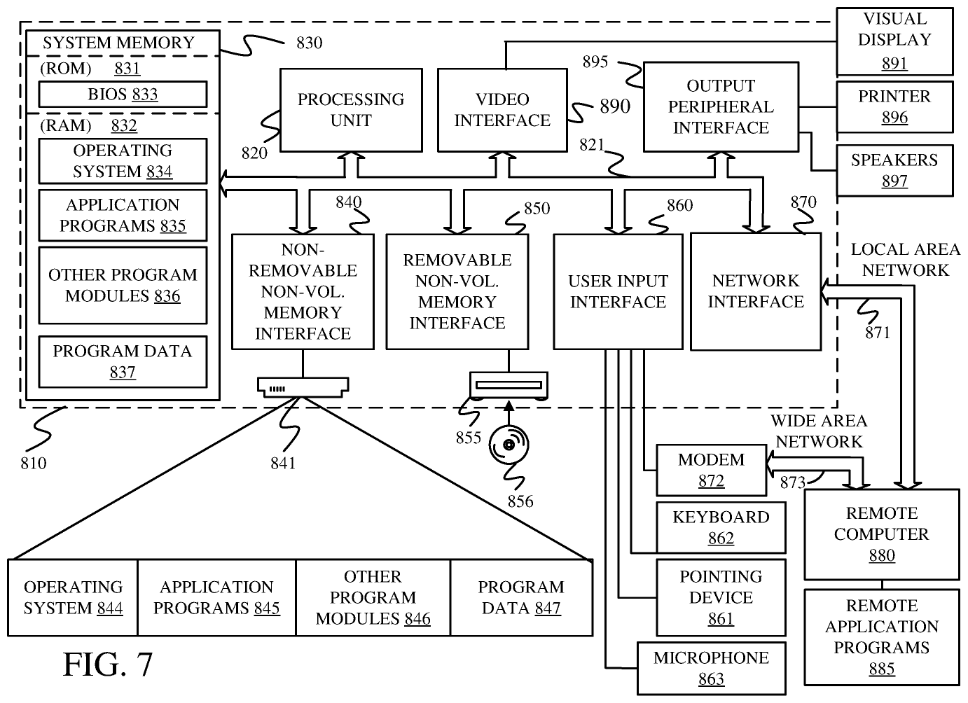

FIG. 7 is one example of a computing environment in which architecture 100, or parts of it, (for example) can be deployed. With reference to FIG. 7, an example system for implementing some embodiments includes a computing device in the form of a computer 810 programmed to operate as described above. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 7.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. Computer storage media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 7 illustrates operating system 834, application programs 835, other program modules 836, and program data 837.

The computer 810 may also include other removable/non-removable volatile/nonvolatile computer storage media. By way of example only, FIG. 7 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 7, provide storage of computer readable instructions, data structures, program modules and other data for the computer 810. In FIG. 7, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 7 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 7 illustrates remote application programs 885 as residing on remote computer 880. It will be appreciated that the network connections shown are examples and other means of establishing a communications link between the computers may be used.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer implemented method, comprising:
automatically detecting an issue identifier, corresponding to an issue, in code stored in a code repository;
automatically obtaining an issue status, indicative of a resolution status of the issue, from an issue tracking system, based on the issue identifier;
accessing issue-related data from the issue tracking system;
automatically identifying a suggested operation to perform on the code in the code repository based on the issue, the issue status, and the issue-related data; and
generating an output to a user interface system indicative of a user interface identifying the suggested operation.

2. The computer implemented method of claim 1 wherein automatically identifying a suggested operation comprises:
generating an artificial intelligence (AI) prompt based on the issue-related data and the issue status;
submitting the AI prompt to an AI model;
receiving a response from the AI model; and
identifying the suggested operation based on the response from the AI model.

3. The computer implemented method of claim 1 wherein automatically identifying a suggested operation comprises:
performing natural language understanding on the issue-related data to obtain a semantic understanding of the issue-related data; and
identifying the suggested operation based on the semantic understanding of the issue-related data.

4. The computer implemented method of claim 1 and further comprising:
determining whether the suggested operation is an operation that can be performed in the code repository automatically; and
if so, generating the output with a selection actuator that is actuatable by a user to automatically perform the suggested operation.

5. The computer implemented method of claim 1 and further comprising:
detecting a location in the code in the code repository where the issue identifier is located.

6. The computer implemented method of claim 5 wherein automatically identifying a suggested operation comprises:
identifying the suggested operation based on the location in the code where the issue identifier is located.

7. The computer implemented method of claim 6 wherein automatically identifying a suggested operation comprises:
identifying code in the issue-related data that is indicative of a suggested workaround; and
identifying the suggested operation based on the code indicative of the suggested workaround.

8. The computer implemented method of claim 7 wherein identifying the suggested operation based on the code indicative of the suggested workaround comprises:
comparing the code indicative of the suggested workaround to the code in the code repository based on the location where the issue identifier is located to determine whether the suggested workaround is implemented as a workaround in the code in the code repository; and
if so, identifying, as the suggested operation, deletion of the workaround implemented in the code in the code repository.

9. The computer implemented method of claim 5 wherein detecting a location comprises identifying a plurality of different locations in the code in the code repository where the issue identifier is located and wherein automatically identifying a suggested operation comprises:
generating, as the suggested operation, an indication that an operation should be performed at the plurality of different locations in the code.

10. The computer implemented method of claim 1 and further comprising:
generating or updating an issue record in a scanning cache based on the issue status.

11. The computer implemented method of claim 1 wherein the issue tracking system exposes a status application programming interface (API) and wherein automatically obtaining an issue status comprises:
calling the status API exposed by the issue tracking system.

12. The computer implemented method of claim 1 wherein the issue tracking system comprises a web page with a status actuator that is actuatable on the web page to obtain the issue status, wherein the issue identifier comprises a reference to the web page, and wherein automatically obtaining an issue status comprises:
accessing the web page based on the issue identifier; and
actuating the status actuator on the web page.

13. The computer implemented method of claim 1 wherein automatically obtaining an issue status comprises:
determining whether the issue status has changed since a last time the issue status was automatically obtained; and
if so, automatically identifying the suggested operation based on the change in the issue status.

14. A computer system, comprising:
an issue detection engine automatically detecting an issue identifier, corresponding to an issue, in code stored in a code repository;
a status detection engine automatically obtaining an issue status, indicative of a resolution status of the issue, from an issue tracking system, based on the issue identifier;
a suggestion engine accessing issue-related data from the issue tracking system and automatically identifying a suggested operation to perform based on the issue, the issue status, and the issue-related data; and
an action signal generator generating an output to a user interface system indicative of a user interface identifying the suggested operation.

15. The computer system of claim 14 wherein the suggestion engine comprises:
an artificial intelligence (AI) prompt generator configured to generate an AI prompt based on the issue-related data and the issue status and to submit the AI prompt to an AI model; and
an AI response processor configured to receive a response from the AI model; and
a suggestion generator configured to identify the suggested operation based on the response from the AI model.

16. The computer system of claim 14 wherein the suggestion engine comprises:
an issue location list generator configured to generate a list of locations in the code stored in the code repository where the issue identifier is located and to generate and output indicative of the issue, the issue status, and the list of locations.

17. The computer system of claim 14 wherein the suggestion engine comprises:
a workaround code identifier configured to identify code in the issue-related data that is indicative of a suggested workaround; and
a code matching system configured to compare the code indicative of the suggested workaround to the code stored in the code repository to determine whether the suggested workaround is implemented as a workaround in the code in the code repository and, if so, identify, as the suggested operation, deletion of the workaround implemented in the code stored in the code repository.

18. A computer system, comprising:
at least one processor; and
a memory storing computer executable instructions which, when executed by the at least one processor, cause the at least one processor to perform steps, comprising:
automatically detecting information indicative of an issue identifier, corresponding to a problem, in code stored in a code repository;
automatically detecting a resolution status of the problem based on the issue identifier;
receiving data that is related to the problem from an issue tracking system;
automatically identifying a suggested action to perform on the code in the code repository based on the resolution status, and the data that is related to the problem; and
causing display of a user interface output on a user interface system, the user interface output identifying the suggested action.

19. The computer system of claim 18 wherein automatically identifying a suggested action comprises:
generating an artificial intelligence (AI) prompt based on the data related to the problem and the resolution status;
submitting the AI prompt to an AI model;
receiving a response from the AI model; and
identifying the suggested action based on the response from the AI model.

20. The computer system of claim 18 wherein automatically identifying a suggested action comprises:
performing natural language understanding on the issue-related data to obtain a semantic understanding of the issue-related data; and
identifying the suggested operation based on the semantic understanding of the issue-related data.
